(19) United States
(12) Patent Application Publication
(10) Pub. No.: US 2011/0170994 A1
(43) Pub. Date: Jul. 14, 2011

(54) TOWING ROBOT

(75) Inventors: David J. Coombs, Arlington, VA (US); David J. Anhalt, Greenwood Village, CO (US)

(73) Assignee: SET CORPORATION, Arlington, VA (US)

(21) Appl. No.: 12/728,010

(22) Filed: Mar. 19, 2010

Related U.S. Application Data
(60) Provisional application No. 61/161,560, filed on Mar. 19, 2009.

(51) Int. Cl. B60P 3/07

(52) U.S. Cl. 414/427

(57) ABSTRACT

A remotely controlled robot for towing a wheeled target vehicle includes a wheel lift assembly having a left side, a right side, and at least one wheel capture arm, at least one drive wheel provided toward each of the left and right sides of the wheel lift assembly, at least one drive motor for driving the drive wheels, and a lift actuating mechanism, wherein the wheel capture arm rotates from the wheel lift assembly to secure a wheel of the target vehicle, and wherein the secured wheel of the target vehicle is raised above a ground surface by the lift actuating mechanism. The lift actuating mechanism may be integrated with the wheel chassis to raise the wheel lift assembly via lift bars. The wheel lift assembly may include a truck assembly and an inclined rail supported on the truck assembly.

### CROSS-REFERENCE TO RELATED APPLICATION

This application claims the benefit of U.S. Provisional Application No. 61/161,560 titled “Towing Robot,” filed Mar. 19, 2009. The disclosure of the prior application is hereby incorporated in its entirety by reference.

### BACKGROUND OF THE INVENTION

1. Field of the Invention

Aspects of the present invention relate to the field of robotic towing and, in particular, to methods, systems, and devices for remotely relocating a vehicle that may be hazardous due to the payload on-board or an improvised explosive device (IED) being attached thereto, for example.

2. Background of the Technology

There is an unmet need in the prior art for safely and effectively relocating a vehicle that may be hazardous to an appropriate location to eliminate or reduce a potential loss of life and/or damage to property. For example, the proliferation of Vehicle-Borne Improvised Explosive Devices (VBEIDs) as a prevalent form of engagement in certain areas of conflict creates a need to remove and/or relocate a vehicle that has been found, or is suspected of, containing explosive ordinance. The goal may be to relocate the VBEID to an open space, prepared blast enclosure, or a protected area, for example, to allow a potential blast force to disperse more safely. In order to perform the relocation operation safely and effectively, a standoff capability must exist so that an Explosive Ordinance Disposal (EOD) operator is not required to physically approach the vehicle in order to relocate the VBEID. Moreover, the system employed for the vehicle relocation operation should be designed for simplicity of operation, for example, to enable military EOD and law enforcement bomb squad personnel to operate and maintain the system with a minimum amount of training required. The system should be compact and transportable in order to be quickly and easily relocated to a desired area while being robust enough to handle a variety of vehicles and/or payloads.

Although described above with reference to a VBEID, the present invention may be used to relocate any vehicle, containing a hazardous material, for example, or to prevent an operator of the removal system from otherwise having to approach the vehicle. For example, an accident on a highway, or a vehicle fire with the accompanying danger of explosion, may require relocation of the vehicle to a less dangerous area in order to reduce potential harm.

### SUMMARY OF THE INVENTION

Aspects of the present invention overcome the above identified problems of the related art, as well as others, by providing methods and systems for remotely relocating a vehicle. Aspects of the present invention allow a safe and effective response to a potentially dangerous situation by providing a compact towing system that can be quickly assembled and/or moved into place in order to relocate a vehicle without requiring an operator of the system to physically approach the vehicle. The methods and systems of aspects of the present invention provide a new capability for safely and effectively responding to potentially hazardous situations and removing or relocating the hazard to an appropriate position.

Additional advantages and novel features of aspects of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 shows an exemplary conventional wheel lift assembly 1 to illustrate various aspects and methods of use of a wheel lift assembly that may be used in accordance with aspects of the present invention;

FIGS. 2-3 show an exemplary remote control vehicle towing robot in accordance with aspects of the present invention;

FIG. 4 shows an exemplary remote control vehicle towing robot with rotating wheel capture arms, in accordance with aspects of the present invention;

FIG. 5 shows exemplary operation of a wheel lift assembly for a remote control vehicle towing robot, in accordance with aspects of the present invention;

FIG. 6 shows a perspective view of an exemplary remote control vehicle towing robot with the wheel lift assembly engaged, in accordance with aspects of the present invention;

FIG. 7 shows yet another perspective view of an exemplary remote control vehicle towing robot with the wheel lift assembly engaged, in accordance with aspects of the present invention;

FIGS. 8-9 show an exemplary remote control vehicle towing robot with a cantilever jack strut, in accordance with aspects of the present invention;

FIG. 10 shows exemplary operation of a wheel lift assembly for the remote control vehicle towing robot with a cantilever jack strut and a jack engaged with the undercarriage of a target vehicle, in accordance with aspects of the present invention;

FIG. 11 shows a perspective view of an exemplary remote control vehicle towing robot with a cantilever jack strut and a jack engaged with the undercarriage of a target vehicle, in accordance with aspects of the present invention;

FIG. 12 shows an exemplary narrow remote control vehicle towing robot, in accordance with aspects of the present invention;

FIG. 13 shows an exemplary narrow remote control vehicle towing robot with a lift jack in an extended position, in accordance with aspects of the present invention;

FIG. 14 shows an exemplary narrow remote control vehicle towing robot with the wheel lift assembly pivoted, in accordance with aspects of the present invention;

FIG. 15 shows an exemplary narrow remote control vehicle towing robot approaching a target vehicle, in accordance with aspects of the present invention;

FIG. 16 shows an exemplary narrow remote control vehicle towing robot with the wheel lift assembly engaged, in accordance with aspects of the present invention;

FIG. 17 shows an exemplary narrow remote control vehicle towing robot in a position for removing a target vehicle;

FIGS. 18A-C show an example of a remote control vehicle towing robot with multiple extendible casters, in accordance with aspects of the present invention

FIG. 19 shows an exemplary narrow remote control vehicle towing robot with an inclined rail assembly, in accordance with aspects of the present invention;

FIG. 20 shows an exemplary narrow remote control vehicle towing robot with an inclined rail assembly approaching a target vehicle, in accordance with aspects of the present invention;

FIG. 21 shows an exemplary narrow remote control vehicle towing robot with an inclined rail assembly approaching a target vehicle, in accordance with aspects of the present invention;

FIG. 22 shows an exemplary narrow remote control vehicle towing robot with an inclined rail assembly with the wheel lift assembly engaged, in accordance with aspects of the present invention;

FIG. 23 shows an exemplary narrow remote control vehicle towing robot with an inclined rail assembly with the wheel lift assembly engaged and the truck lever extended, in accordance with aspects of the present invention;

FIG. 24 shows an exemplary narrow remote control vehicle towing robot with an inclined rail assembly with the wheel lift assembly engaged and the truck assembly moving into a forward position, in accordance with aspects of the present invention; and

FIG. 25 shows an exemplary narrow remote control vehicle towing robot with an inclined rail assembly with the wheel lift assembly engaged and the truck assembly in a position for removing the target vehicle, in accordance with aspects of the present invention.

### DETAILED DESCRIPTION

The present invention is described more fully hereinafter with reference to the accompanying drawings, in which various aspects of a towing robot are shown. This invention, however, may be embodied in many different forms and should not be construed as limited by the various aspects of the towing robot presented herein. The detailed description of the towing robot is provided below so that this disclosure will be thorough and complete, and will fully convey the scope of the present invention, without limiting it, to those skilled in the art.

The detailed description may include specific details for illustrating various aspects of a towing robot. However, it will be apparent to those skilled in the art that the invention may be practiced without these specific details and is applicable to various other aspects.

Various aspects of a towing robot may be illustrated by describing components that are coupled, attached or connected together. As used herein, the terms “coupled,” “attached,” and “connected” may be used to indicate either a direct connection between two components or, where appropriate, an indirect connection to one another through intervening or intermediate components. In contrast, when a component is referred to as being “directly coupled,” “directly attached” or “directly connected” to another component, there are no intervening elements present.

Relative terms such as “lower” or “bottom” and “upper” or “top” may be used herein to describe one element's relationship to another element illustrated in the drawings. It will be understood that relative terms are intended to encompass different orientations of a towing robot in addition to the orientation depicted in the drawings. By way of example, if a towing robot in the drawings is turned over, elements described as being on the “bottom” side of the other elements would then be oriented on the “top” side of the other elements. The term “bottom” can therefore encompass both an orientation of “bottom” and “top” depending on the particular orientation of the apparatus.

Various aspects of a towing robot may be illustrated with reference to one or more exemplary embodiments. As used herein, the term “exemplary” means “serving as an example, instance, or illustration,” and should not necessarily be construed as preferred or advantageous over other embodiments of a towing robot disclosed herein.

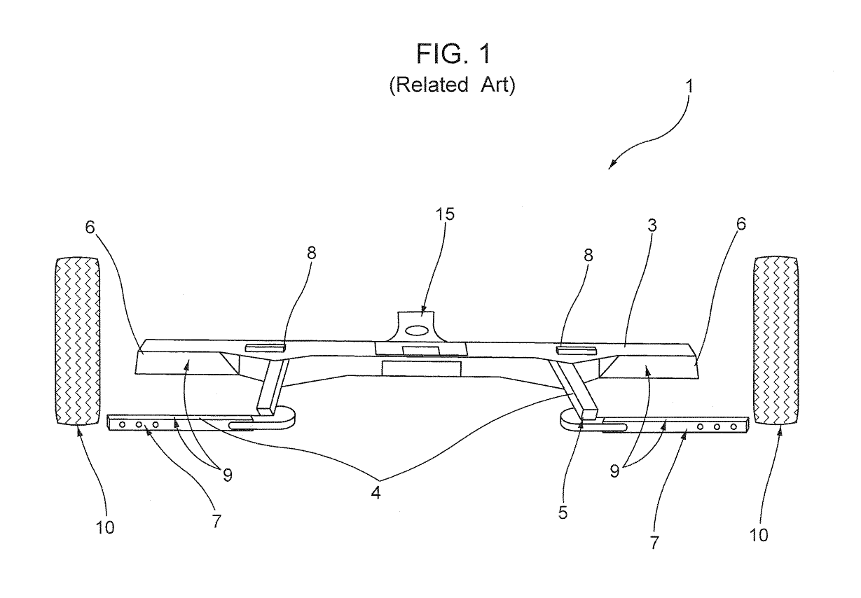

FIG. 1 shows an exemplary conventional wheel lift assembly 1 to illustrate various aspects and methods of use of a wheel lift assembly that may be used in accordance with the present invention. The wheel lift assembly 1 may include a frame axle 3 and pivoting wheel capture arms 4. The wheel capture arms 4 may be formed with, or from multiple structural components to create an elbow 5 that provides the wheel capture arms with a generally L-shaped dimension. The frame axle 3 may include wheel mounts 6 designed to slide wedge-like under drive wheels 10 of a target vehicle (not shown). Electric jacks 8 may be mounted to, or located inside of, the frame axle 3, for example, to pivot the wheel capture arms 4 to surround the drive wheels 10 of the target vehicle. As shown in FIG. 1, the wheel lift assembly 1 may be pivotally attached to a towing frame 15. In a stowed position, the wheel capture arms 4 are folded inward so that the elbows 5 of each arm 4 are flush with the frame axle 3 and free end portions 7 of the wheel capture arms 4 extend adjacently from the center of the frame axle 3. In operation, the wheel lift assembly 1 with the wheel capture arms 4 folded inward, moves toward a vehicle until the frame axle 3 makes contact with the vehicle drive wheels 10. Preferably, the frame axle 3 is pushed to force the wheel mounts 6 to wedge under the vehicle drive wheels 10. Once the frame axle 3 makes contact with the drive wheels 10, the wheel capture arms 4 may rotate out from the folded position by means of the electric jacks 8 so that the free end portions 7 wrap around and cradle the drive wheels 10. The drive wheels 10 become essentially locked in place between the frame axle 3 and the free end portions 7 of the wheel capture arms 4. In this manner, different size wheel capture arms 4 may be used, or a means for varying the dimension of a wheel gap 9 created when the wheel capture arms 4 pivot around the drive wheels 10 of the target vehicle may be provided. The wheel gap 9 is dimensioned to cradle and support the drive wheels 10 by being smaller than the diameter of the drive wheels 10 of the target vehicle. Once the drive wheels 10 are cradled in the wheel gap 9, the towing frame 15 is raised to lift the drive wheels 10 off a ground surface. As the drive wheels 10 of the target vehicle become elevated, the target vehicle may be moved by an associated movement of the wheel lift assembly 1.

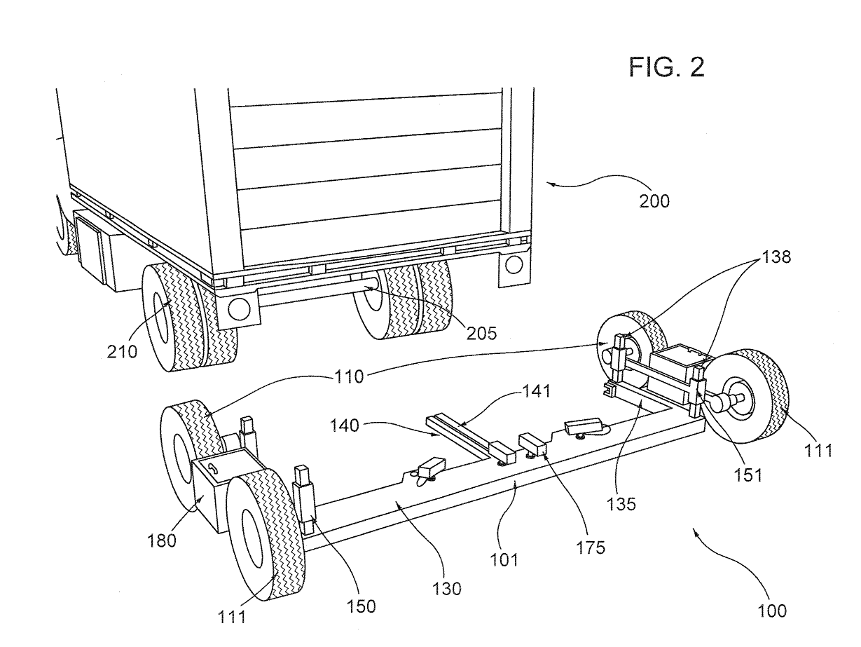

FIG. 2 shows an exemplary VBIED Compact Towing Robot (VCToR) 100 in accordance with aspects of the present invention. A wheel lift assembly system 101 is shown suspended from a left and right wheel chassis 150, 151. The wheel lift assembly system 101 includes a frame axle 130 and pivoting wheel capture arms 140, 141. The wheel capture arms 140, 141 are shown in the folded inward position and may be pivotally controlled by electric or hydraulic jacks (not shown) that are mounted internally to the frame axle 130. The frame axle 130 may be of steel beam construction or any suitable material capable of supporting the transverse loads typically supported by a drive axle 205 of a target vehicle 200. As shown in FIG. 2, the frame axle 130 may have side frame bars 135 connected to lift bars 138. The lift bars 138 mount to the wheel chassis 150, 151 and may be hydraulically or electrically actuated to lift or lower the wheel lift assembly system 101 by a remote control system, for example. Systems and components of the present invention may derive power and actuation through hydraulic, direct tethered hydraulic, direct tethered electrical, battery operated, gas or diesel means integrated with the frame and chassis of the exemplary VCToR, as would occur to one of ordinary skill in the art.

The wheel chassis 150, 151 may include a chassis frame and any variety of components known in the art for dynamic support and control of a load, including, for example, shock absorbers, braking mechanisms, and an independent wheel control system to provide maneuverability of the VCToR 100. As shown in FIG. 2, the VCToR has a first set of wheels 110 and a second set of wheels 111. The wheels may be independently controlled or controlled in a manner such that the first set of wheels 110 remain fixed, for example, while the second set of wheels 111 are capable of turning and provide the primary steering capability. As such, the second set of wheels 111 may incorporate a tie rod mechanism (not shown), for example, to provide increased synchronous control, as long as the tie rod does not interfere with the clearance of the wheel lift assembly 101 in loading a target vehicle 200. Although shown with two sets of wheels 110, 111, the VCToR 100 may have any number of wheels or may use a track system, for example, to further distribute the load while providing adequate traction and maneuverability. The wheels 110, 111 may be driven by a high torque, low speed drive motor (not shown). The drive motor(s) may be mounted on the chassis 150, 151 or each wheel 110, 111 may be individually mounted with a wheel drive motor (not shown), for example. The wheel chassis 150, 151 may additionally provide support for system components including a remote control system, hydraulic and/or electric lines, pumps, motors, actuators, and rechargeable batteries, for example, parts of which may be contained in a protected enclosure as illustrated by accessible box 180.

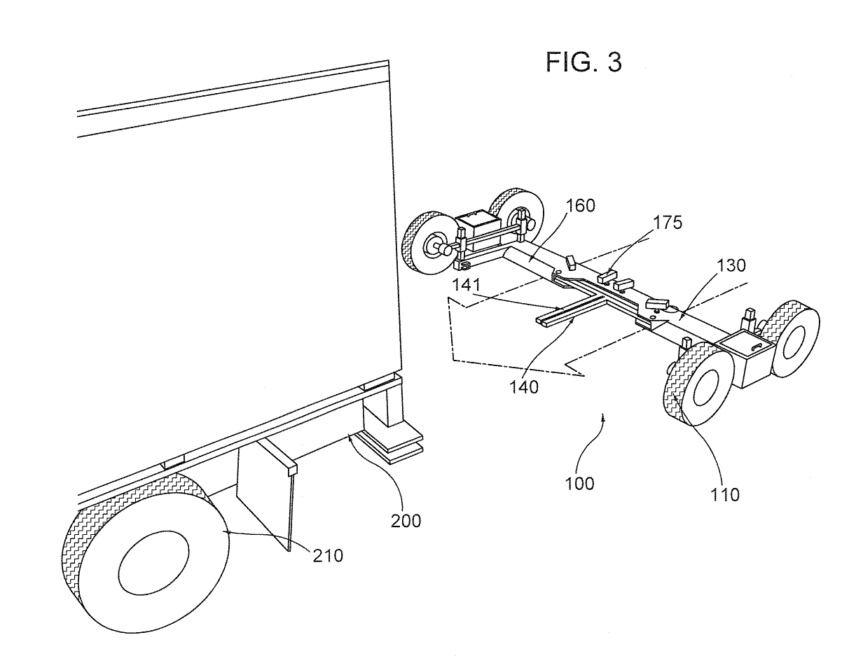

The VCToR 100 may be modularly constructed or assembled to have an internal clearance width greater than a transverse width of the drive wheels 210 on the target vehicle 200. As shown in FIG. 3, the VCToR 100 may have cameras 175 mounted at predetermined positions on the frame axle 130, for example, to provide a remote operator the ability to control the VCToR 100 in an approach to the target vehicle 200. Although described herein with fixed cameras, aspects of the present invention may include pan-tilt-zoom cameras, or any number of other useful contact and non-contact sensors (e.g., a Global Positioning System (GPS), inertial sensors, a compass, etc.) for navigating, positioning, or engaging the target vehicle to be towed. The wheel capture arms 140, 141 are shown in the folded inward position to permit the VCToR 100 to easily gain access to the undercarriage portion of the target vehicle 200. In this manner, the remote operator will maneuver the VCToR 100 to approach the target vehicle 200 so that the first set of wheels 110 may pass to the outside of the drive wheels 210 of the target vehicle 200. The operator will maneuver the VCToR 100 toward the drive wheels 210 until the frame axle 130 makes contact with the drive wheels 210. The operator may advance the VCToR 100 until the wedge-like wheel mounts 160 formed in the frame axle 130 are forced as far under the drive wheels 210 as possible.

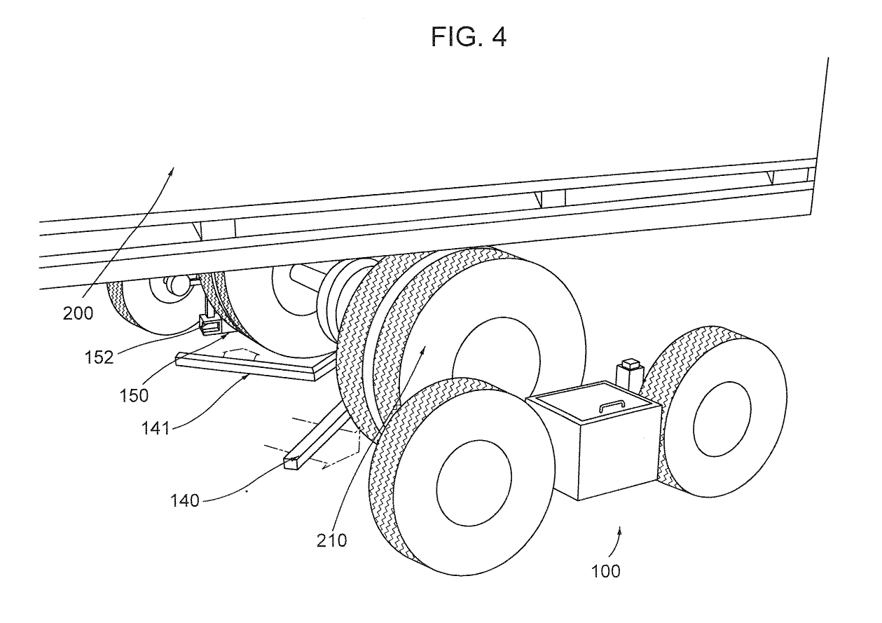

As shown in FIG. 4, once the VCToR 100 is in position against the drive wheels 210 of the target vehicle 200, the wheel capture arms 140, 141 may be rotated radially outward from the drawn inward center position toward the wheel chassis 150, 151. The rotation of the wheel capture arms 140, 141 may be initiated by remote control from the operator or be automated once the VCToR 100 senses contact with the drive wheels 210 of the target vehicle 200. Although in towing a vehicle, it is preferential to lift the drive wheels 210, aspects of the present invention are not limited to the drive wheels 210 of the target vehicle 200 and the VCToR may be controlled to lift any wheel or set of wheels on a target vehicle 200, as is appropriate for the circumstances. As also shown in FIG. 4, detents 152 (153 not shown) may be provided on the chassis 150, 151 or side frame bars 135 to lock into place and/or support the wheel capture arms 140, 141, once the wheel capture arms 140,141 are closed and cradling the drive wheels 210 of the target vehicle 200.

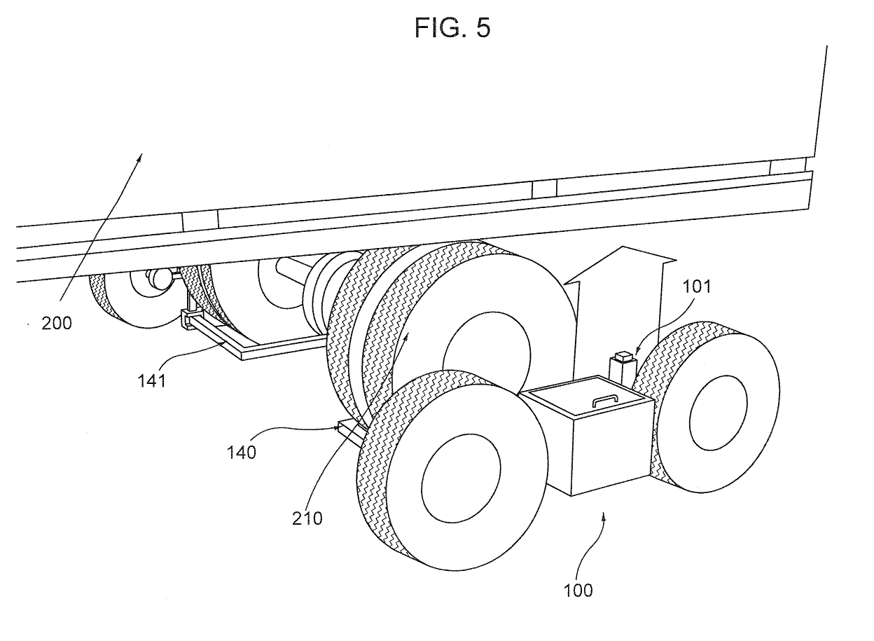

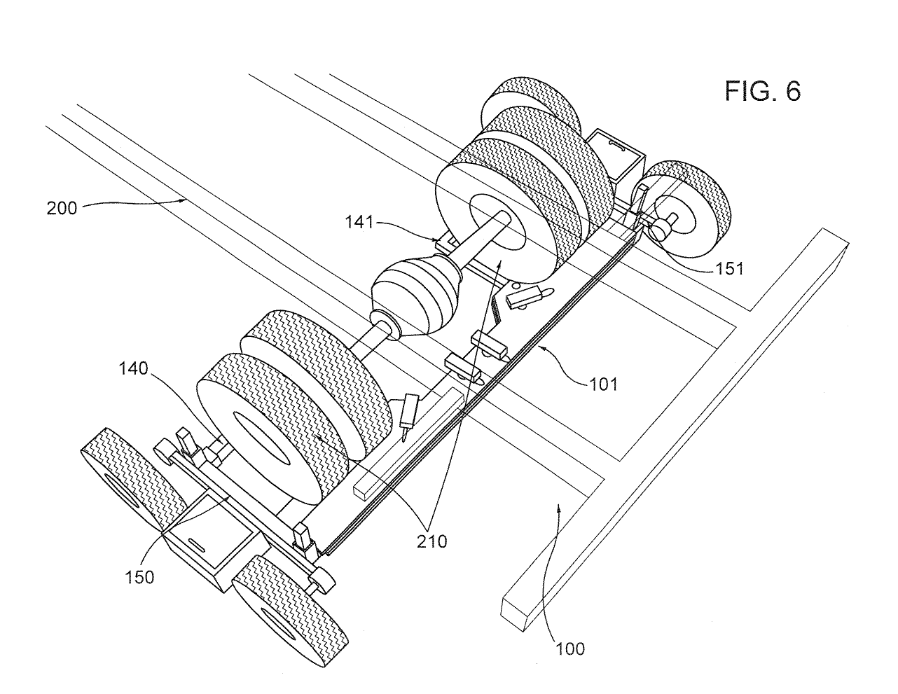

FIG. 5 shows that the VCToR 100 may employ the wheel lift assembly 101 to lift the drive wheels 210 of the target vehicle 200 once the wheel capture arms 140, 141 are in a fully closed position, in effect cradling the drive wheels 210. Lift jacks (not shown), for example, may be mounted on the wheel chassis 150, 151 to provide the necessary force to lift the cradled drive wheels 210 by elevating the wheel lift assembly 101. For example, the VCToR 100 may be provided with commercial off-the-shelf (COTS) jacks capable of lifting a wheel lift assembly 101 that is supporting a load of up to three tons to a height of up to six inches. As also shown in FIG. 6, the weight of the target vehicle 200, normally supported by the drive wheels 210, is thus displaced and supported by the wheel lift assembly 101 in combination with the wheel chassis 150, 151 and the wheels 110, 111 of the VCToR 100. Each step in the process, such as the closing of the wheel capture arms 140, 141 or the activation of the wheel lift assembly 101 to lift the drive wheels 210 of the target vehicle 200, may be remotely initiated and controlled, via wired or wireless remote control by an operator in a position safely away from the vehicle 200.

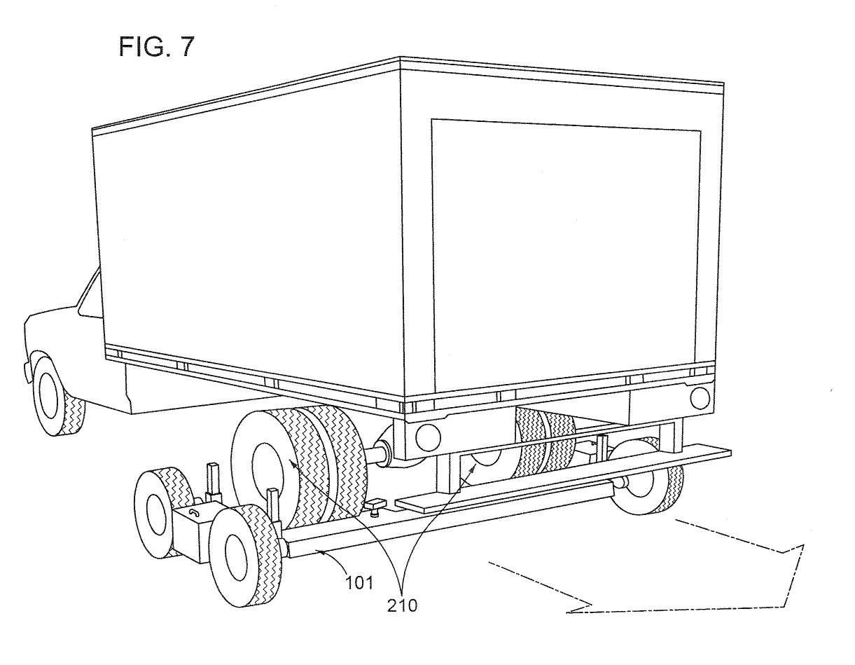

FIG. 7 shows that once the wheel lift assembly 101 has elevated the drive wheels 210 off of the ground, the operator may remotely command the VCToR 100 to maneuver to a more appropriate location for disarming or disabling the threat, for example. As described herein, aspects of the present invention may include remote control, autonomous control, and any mixture of remote/semi-autonomous control for controlling the drive and navigation systems during navigation to, and navigation from, a vehicle to be towed, as well as for controlling operation and actuation of systems in order to approach, engage and secure the target vehicle. Furthermore, operator communications and control may be provided by a control system via wire, internet, optical fiber, or wireless communications (e.g., radio frequency (RF), infrared (IR), laser), for example. The control system may enable an operator to engage a vehicle by line of sight, from behind a blast barrier, or from the other side of the globe on a computer screen, for example. Accordingly, aspects of the present invention, and in particular, the control system of the VCToR, may be implemented using hardware, software or a combination thereof and may be implemented in one or more computer systems or other processing systems capable of carrying out the functionality described herein.

The VCToR 100 is designed to exploit the target vehicle's 200 own weight to gain traction using high torque, low speed drive motors (not shown). The VBIED, for example, may be relocated to an intersection, vacant lot, or other location that allows the blast force to disperse rapidly, provides other lower value surroundings, or contains an emplaced blast enclosure specially prepared for the purpose of dealing with the threat or hazard. The preparation of a blast enclosure, for example, may now be accomplished at a safe distance from the VBIED, reducing personnel risk. The cameras 175 may be controlled to rotate horizontally or vertically in order to provide the operator a clear view during the extraction maneuvers,

Although shown in the drawings as generally approaching the target vehicle 200 straight-on, the VCToR 100 may be operated to approach the target vehicle 200 from an angle or perpendicular to the target vehicle 200, for example. Once the frame axle 130 makes contact with a nearest wheel to the angle of approach, the VCToR 100 may be controlled to pivot around the contact point with the near wheel until the frame axle 130 also contacts the farthest wheel from the angle of approach. Once the frame axle 130 is thus situated transverse to a longitudinal axis of the target vehicle 200 and wedged under the drive wheels 210, the wheel lift assembly 101 operates as described herein to elevate and maneuver the target vehicle 200 to a different location.

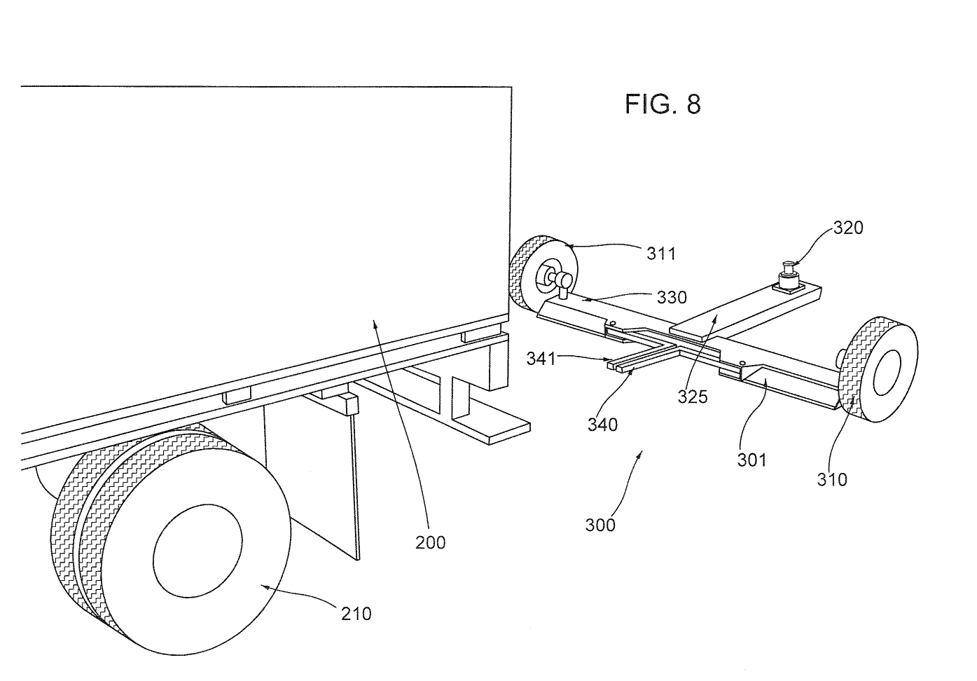

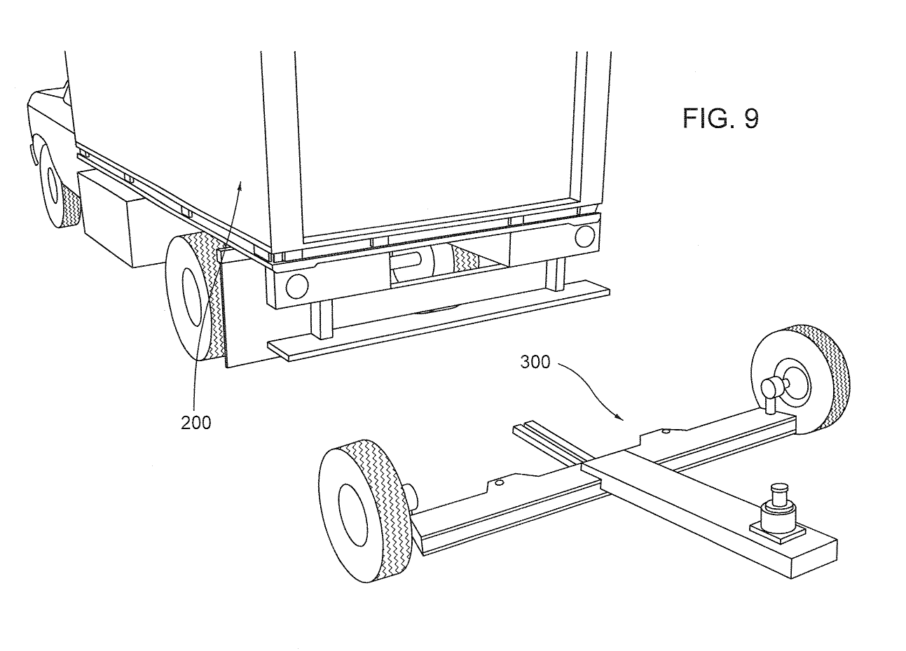

FIG. 8 shows an exemplary VCToR 300 in accordance with aspects of the present invention. A wheel lift assembly 301 is supported by a left wheel 310 and a right wheel 311 with high torque, low speed drive motors (not shown) provided to drive the wheels. Many of the components and aspects of the wheel lift assembly 301 are similar to, or the same as, the wheel lift assembly 101 disclosed above. As shown in FIG. 8, a jack 320 may be mounted on a jack strut 325, the jack strut 325 being connected to the frame axle 330 of the wheel lift assembly 301 so as to be cantilevered in a direction opposite from the extension of the wheel capture arms 340, 341 when the wheel capture arms 340, 341 are in a folded inward position. A plate or platform (not shown), for example, may be provided on the top of the jack 320 to provide increased surface area for pushing up on a structural component of the target vehicle 200. FIG. 9 shows a different view of an exemplary VCToR 300 approaching a target vehicle 200. The wheel lift assembly 301 is supported by the wheels 310, 311 to be slightly above ground level.

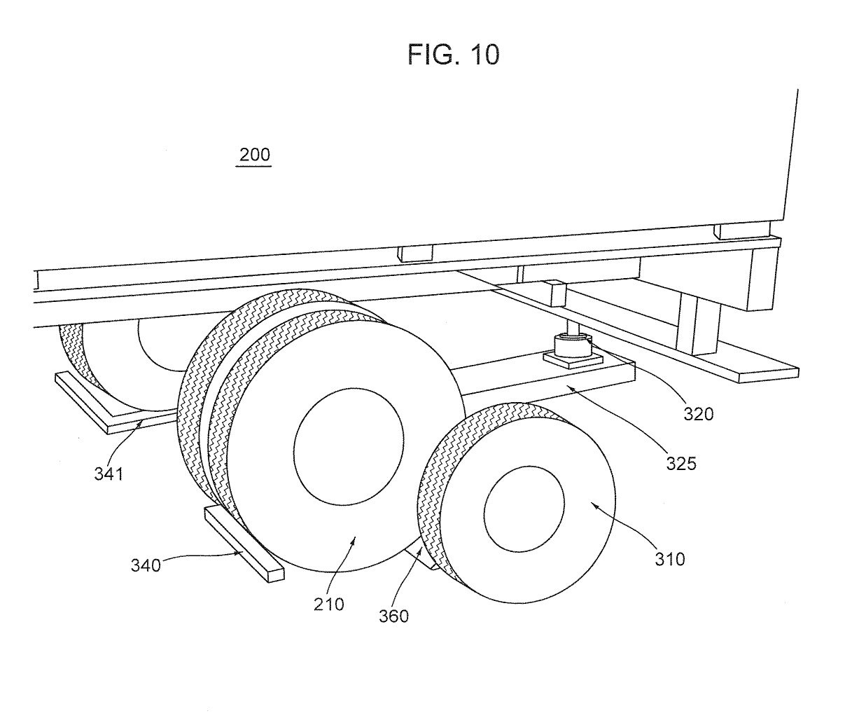

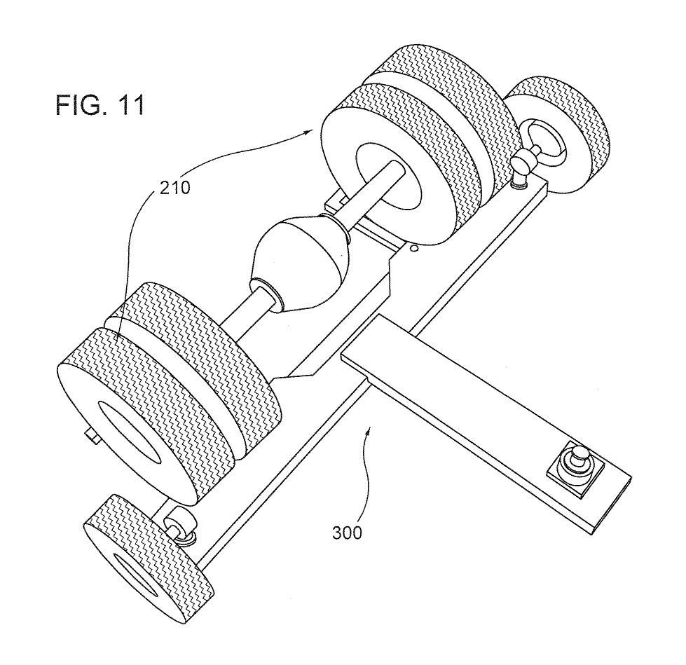

The VCToR 300 may be controlled by remote control to approach the target vehicle 200. As shown in FIG. 10, once the frame axle 330 makes contact with the drive wheels 210 of the target vehicle 200, the wedge-like wheel mounts 360 may be driven against the drive wheels 210 and the wheel capture arms 340, 341 rotated to cradle the drive wheels 210. The jack 320 may then be raised to contact a portion of the undercarriage, such as the bumper or the frame, for example. Continued upward thrust of the jack 320 applies a cantilever force on the jack strut 325, providing leverage to lift the cradled drive wheels 210 onto wheel mounts 360. As shown in FIG. 11, the drive wheels 210 are cradled and elevated slightly above ground level so that the VCToR 300 may be controlled to move the target vehicle 200 to a different location.

As described previously, various aspects of the present invention such as cameras and brakes may be mounted onto the VCToR 300 to provide a greater degree of control for the vehicle without interfering with the operation of the wheel lift assembly 301. Hydraulic or electric lines may be stowed in the hollows of structural components or clipped underneath structural components of the VCToR for protection from the elements and ease of access for maintenance purposes.

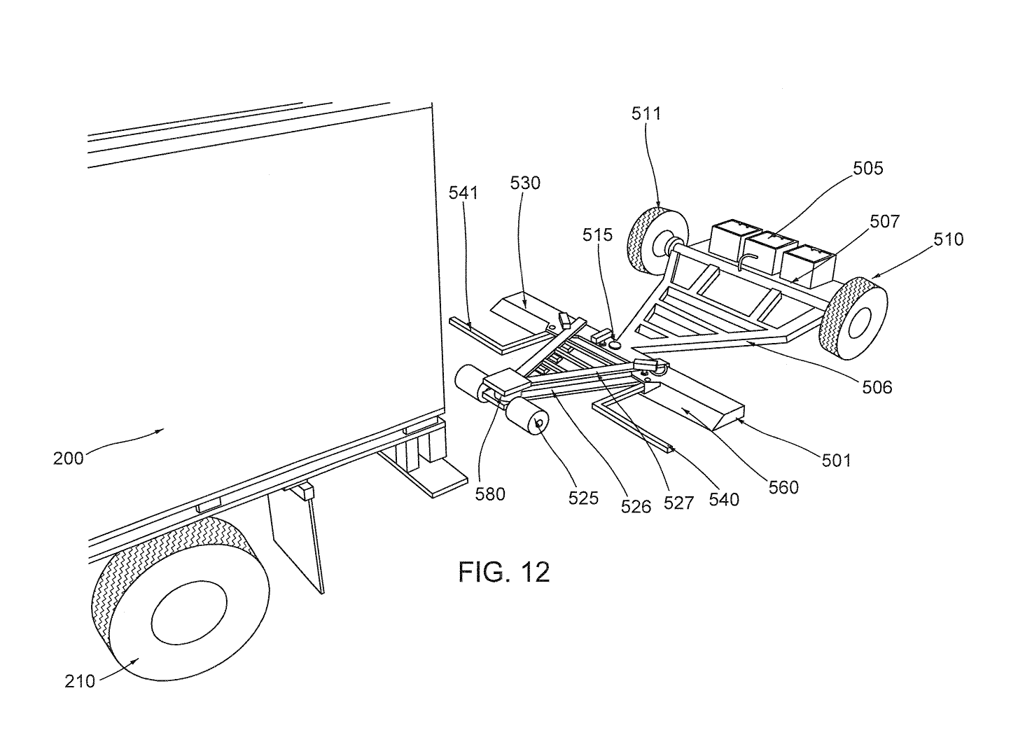

FIGS. 12-17 show an exemplary VCToR 500 in accordance with aspects of the present invention. Where the target vehicle 200 may be alongside a curb, for example, making perimeter access to the vehicle difficult or impossible for the wheels of the VCToR 100 or VCToR 300, a narrow VCToR 500 with a rear drive assembly 505 having an extended support structure 506 connected to a wheel lift assembly 501 at a center joint 515 may be used. The narrow VCToR 500 has drive wheels 510, 511 mounted on an axle 507 with the same or narrower width than the wheel lift assembly 501. The extended support structure 506 may be formed to provide adequate longitudinal clearance between the target vehicle 200 and the rear drive wheels 210 when the wheel lift assembly 501 is engaged with the drive wheels 210. Thus, the rear drive wheels 510, 511 are not limited to a particular ground clearance diameter and may be sized appropriately to provide substantial traction and drive capability to the VCToR system 500. Having the extended support structure 506 allows the forward wheel lift assembly 501 to maintain a low profile. The combination of the narrower transverse width of the wheels 510, 511 and the lower profile of the forward wheel lift assembly 501 allows the VCToR 500 to more easily approach a target vehicle 200 that may have perimeter obstacles or may be a smaller vehicle, thus providing a lower clearance for gaining access to the drive wheels 210.

The forward wheel lift assembly 501 has rotating wheel capture arms 540, 541 and wheel mounts 560 that are integrated with a wheel lift crossbeam 530. Front rollers 525 may be supported by a lower front frame 526, which is hinged to a lower surface of the wheel lift crossbeam 530. Interchangeable front rollers 525 of varying diameters may be used with the VCToR system 500 according to the expected load and/or ground clearance of the target vehicle 200. As long as the rollers 525 are able to fit underneath the target vehicle 200, a larger diameter generally provides for greater weight bearing capability while permitting the VCToR system 500 enhanced drive capabilities over uneven terrain, for example. The lower front frame 526 may be formed to extend longitudinally forward from the hinged connection to the wheel drive assembly 501 so that the wheel capture arms 540 and 541 have adequate clearance to rotate out from the wheel lift assembly 501 to engage and capture the drive wheels 210.

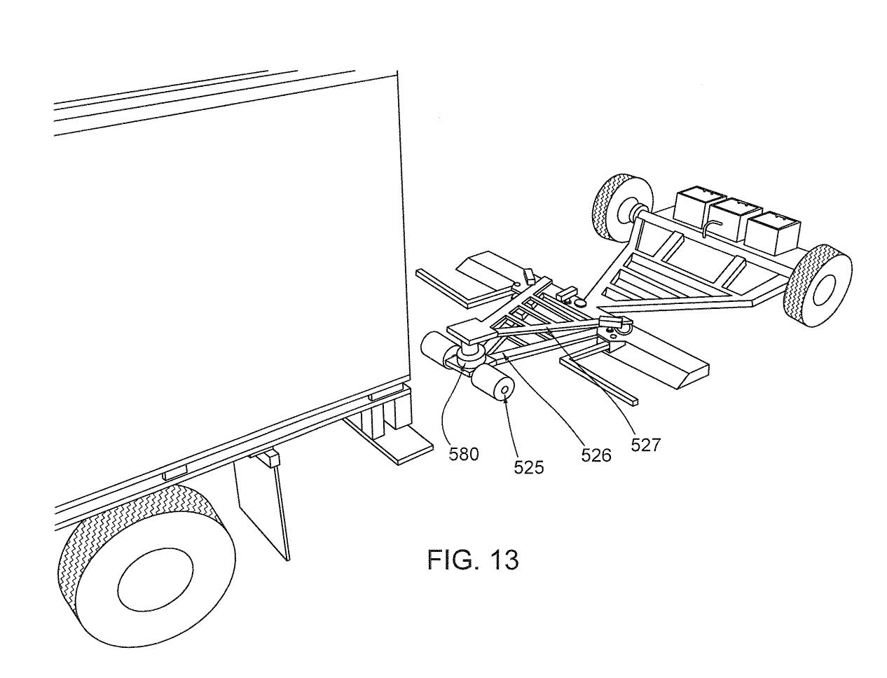

An upper front frame 527 may be provided that is rigidly attached to the wheel lift crossbeam 520. The lower front frame 526 and the upper front frame 527 are attached to the wheel lift crossbeam 530 with adequate vertical clearance between the frames 526 and 527 for the wheel capture arms 540, 541 to freely rotate from a stored inward folded position to an extended position in order to cradle the target drive wheels 210. A forward hydraulic lift jack 580 may be mounted, for example, on the lower front frame 526 directly above or toward the front rollers 525. The hydraulic lift jack 580 may be connected to the upper front frame 527 to lift the upper front frame 527, as shown in FIG. 13.

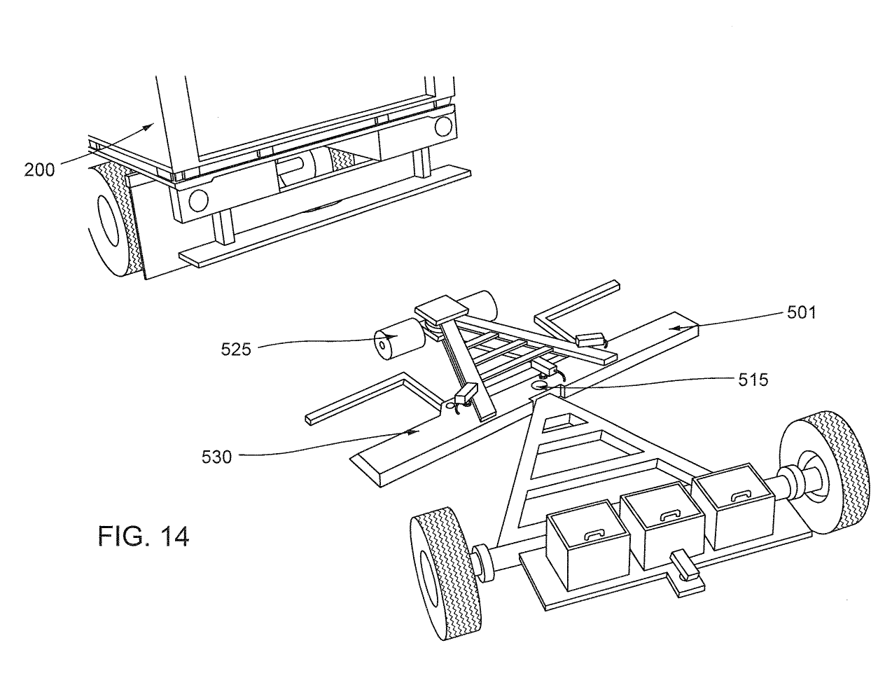

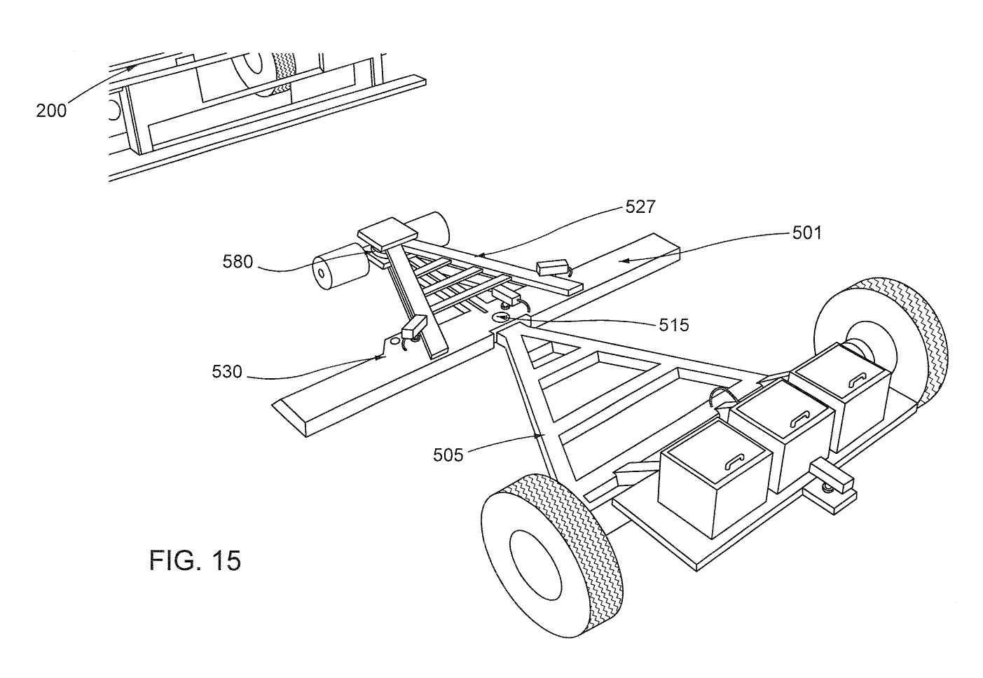

The operator may control the VCToR 500 to approach the target vehicle 200. As shown in FIG. 14, for example, the approach may be from an angle or substantially perpendicular to the target vehicle 200, as the center joint 515 may pivot to allow substantially horizontal radial motion of the wheel lift assembly 501. Once the wheel lift crossbeam 530 of the wheel lift assembly 501 makes contact with the drive wheels 210 of the target vehicle 200, the wheel lift assembly 501 may be driven to wedge the wheel mounts 560 against the rear of the drive wheels 210. The wheel capture arms 540, 541 may be controlled to rotate radially from a folded inward position to lock around the wheels 210, in effect cradling the wheels 210. As shown in FIG. 15, although the center joint 515 allows substantially horizontal pivoting of the wheel lift assembly 501 with respect to the extended support structure 506, the center joint 515 is formed to provide rigid longitudinal support to the wheel lift assembly 501 when the upper front frame assembly 527 is lifted by the lift jack 580.

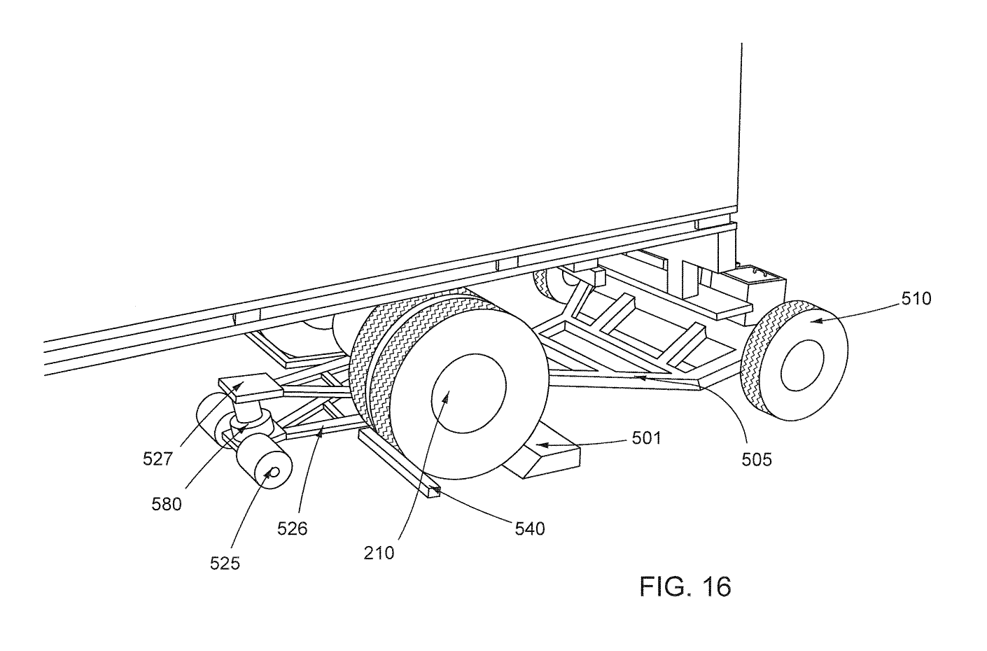

Thus, once the VCToR 500 has secured the drive wheels 210 and the lift jack 580 is extended, as shown in FIG. 16, the upper front frame assembly 527 is raised away from the lower front frame assembly 526. Because the upper front frame assembly 527 is rigidly connected to the wheel lift assembly 501, when the upper front frame assembly 527 raises, the wheel lift assembly 501 raises as well, and the drive wheels 210 are elevated from the ground surface. The rigid longitudinal connection at the center joint 515 between the extended support structure 506 and the wheel lift assembly 501, combined with the rigid connection of the upper front frame assembly 527, ensures that the drive wheels 210 are raised in cantilevered fashion from a fulcrum point at the rear axle between the wheels 510, 511. As the wheel lift assembly 501 is raised, the load of the target vehicle 200 transfers to the rollers 525 and the rear wheels 510, 511.

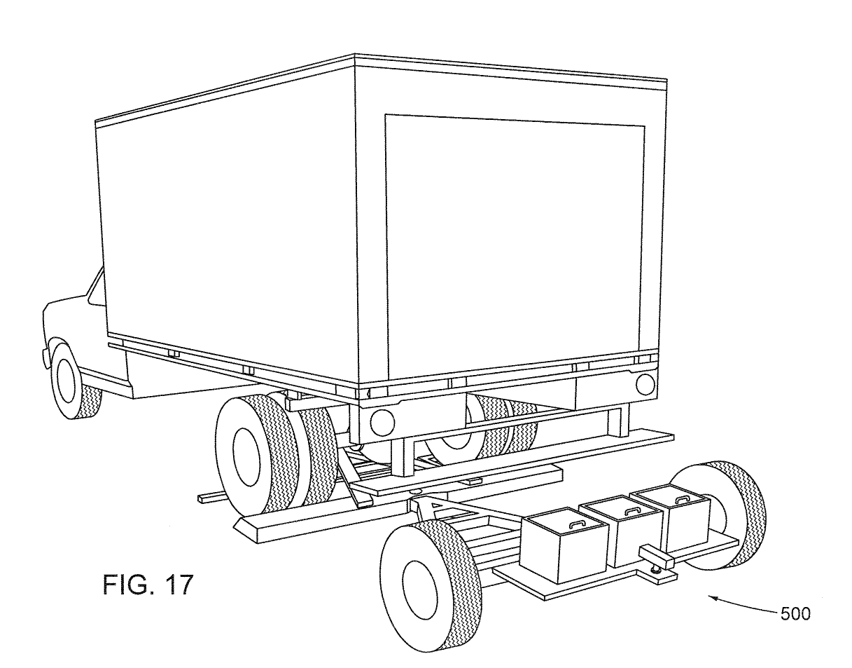

FIG. 17 shows that once the wheel lift assembly 501 has been elevated off the ground, along with the drive wheels 210, the operator may remotely command the VCToR 500 to maneuver to a more appropriate location for disarming or disabling the threat, for example.

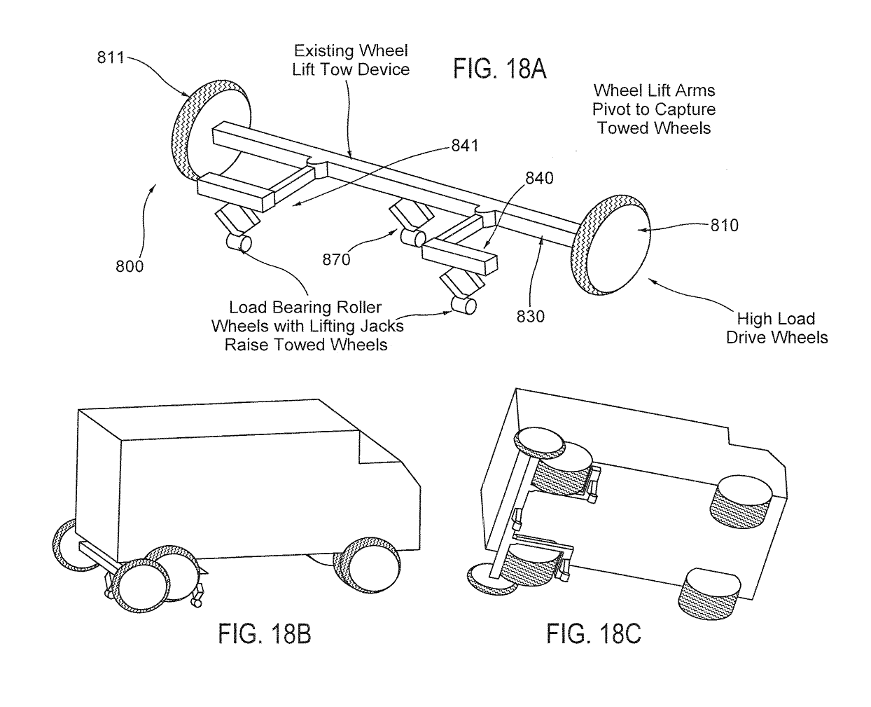

FIGS. 18A-C illustrate aspects of an exemplary VCToR system 800 that may include extendible load bearing roller wheel assemblies 870 provided at predetermined positions on the wheel capture arms 840, 841 and/or the frame axle 830 in order to raise the drive wheels 210 of a target vehicle 200. The extension of the load bearing roller wheel assemblies 870 may be accomplished by lifting jacks, for example, mounted to the wheel capture arms 840, 841 and/or the frame axle 830. Once the operator positions the VCToR 800 so that the frame axle 830 contacts the drive wheels 210 of a target vehicle 200, the wheel capture arms 840, 841 pivot to capture and cradle, for example, the towed drive wheels 210. The load bearing roller wheel assemblies 870 may be activated to extend in order to elevate the drive wheels 210 off the drive surface. The high load drive wheels 810, 811 of the VCToR 800 may be controlled by the operator to move the target vehicle 200 to an alternate location.

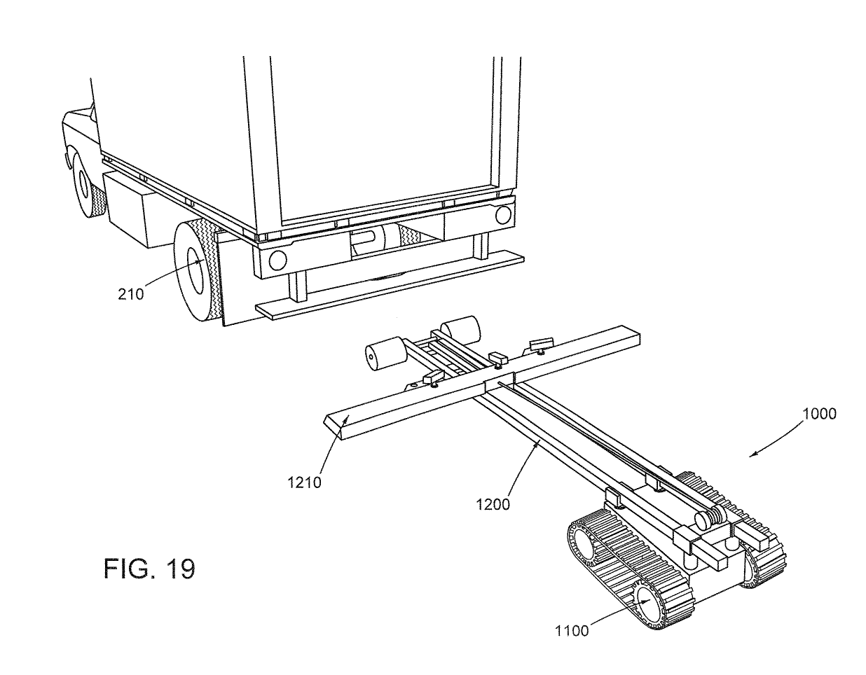

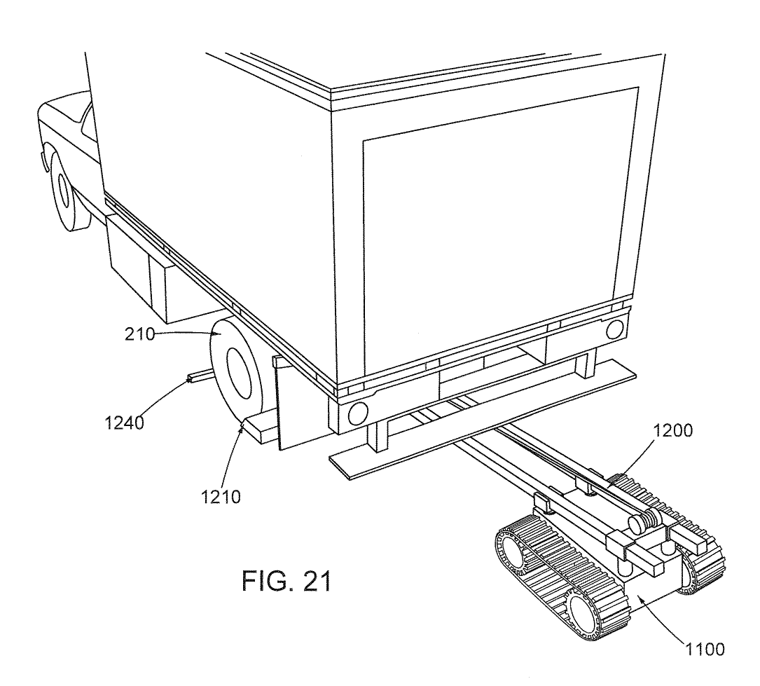

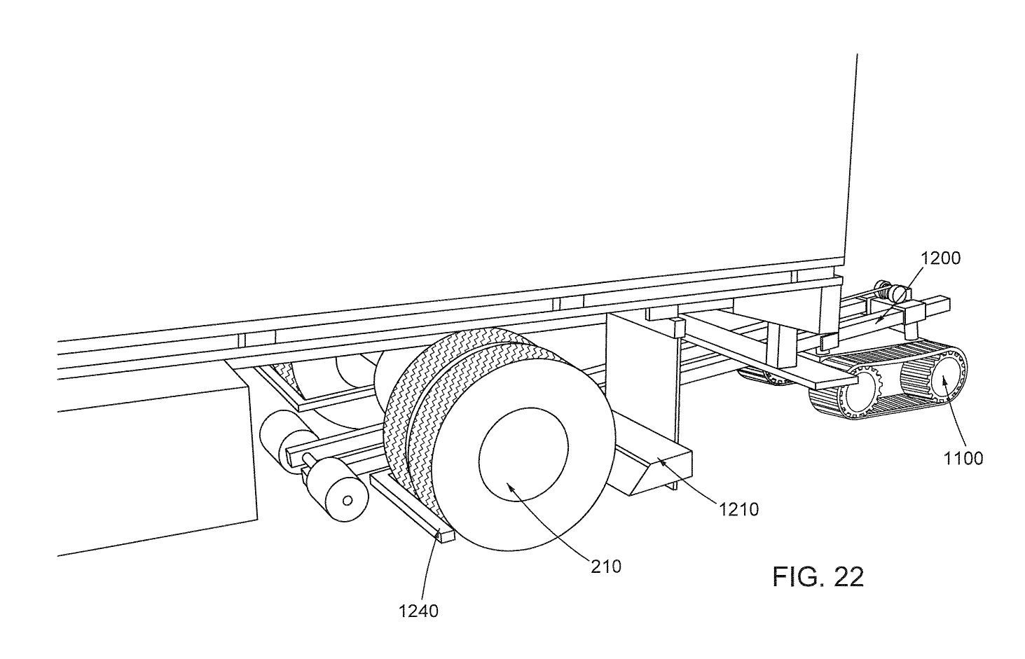

FIGS. 19-25 herein illustrate aspects of an exemplary VCToR system 1000. The VCToR system 1000 has a transverse dimension that is as narrow or narrower than the transverse dimension of the target vehicle to be towed, in accordance with aspects of the present invention. The VCToR system 1000 has a base truck assembly 1100 that supports an inclined rail assembly 1200.

The truck assembly 1100, although shown with tracks, may use wheels, for example, to distribute the load while providing adequate traction and maneuverability. The wheels may be driven by a high torque, low speed drive motor (not shown). The drive motor(s) may be mounted on the chassis of the truck assembly 1100 or may be individually mounted with a wheel drive motor (not shown), for example. The truck assembly chassis may additionally provide support for various system components including a remote control system, hydraulic and/or electric lines, pumps, motors, actuators, and rechargeable batteries, for example.

The inclined rail assembly 1200 extends forward from the truck assembly 1100 and supports a wheel lift assembly 1210. The wheel lift assembly 1210 includes left and right wheel capture arms 1240, 1241 that may operate as previously described herein to capture and support the drive wheels 210 of a target vehicle 200. Support rollers 1250 may be provided at a distal end of the inclined rail assembly 1200.

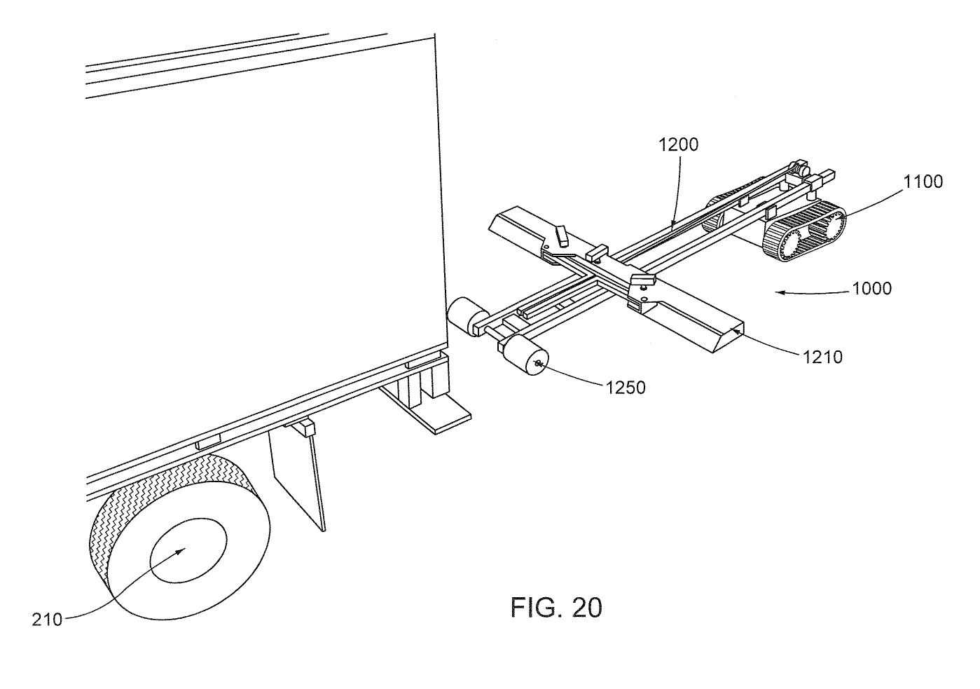

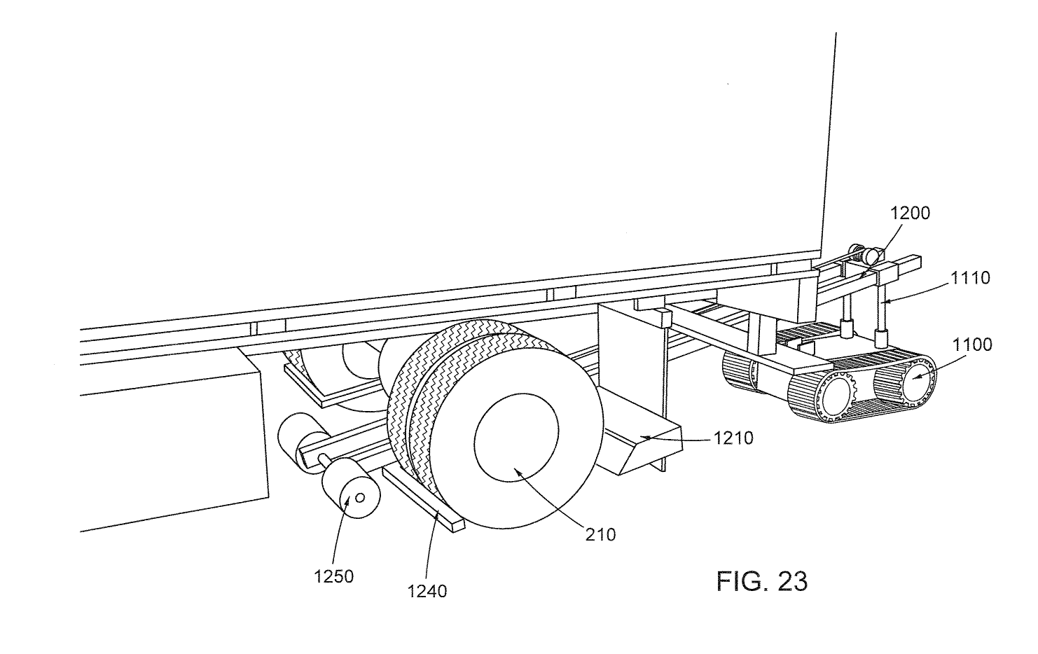

As shown in FIG. 20-22, the truck assembly 1100 may be guided, for example, to approach the target vehicle 200 so that the extended inclined rail assembly 1200 supporting the wheel the lift assembly 1210 slides under the target vehicle chassis and into a position wherein the wheel capture arms 1240 and 1241 may engage and capture the drive wheels 210 of the target vehicle 200. As shown in FIG. 23, a truck lever 1110, which may be hydraulic jack lifts, for example, may be mounted to the truck assembly 1100 and attached to a proximal end of the inclined rail assembly 1200. The truck lever 1110 applies lift to the proximal end of the inclined rail assembly 1200 so that the rigidly connected inclined rail assembly 1200 rotates and forces the support rollers 1250 to abut the ground surface and form a fulcrum point for continued elevation of the inclined rail assembly 1200. As the inclined rail assembly 1200 lifts, the target vehicle drive wheels 210 captured by the drive wheel assembly 1210 may elevate from the ground surface. Thus, the load supported by the rear axle and drive wheels 210 of the target vehicle 200 is transferred to the rigid structure of the inclined rail assembly 1200, with the load being supported on the ground in a shared manner by the truck assembly 1100 at one end and the support rollers 1250 at the other end.

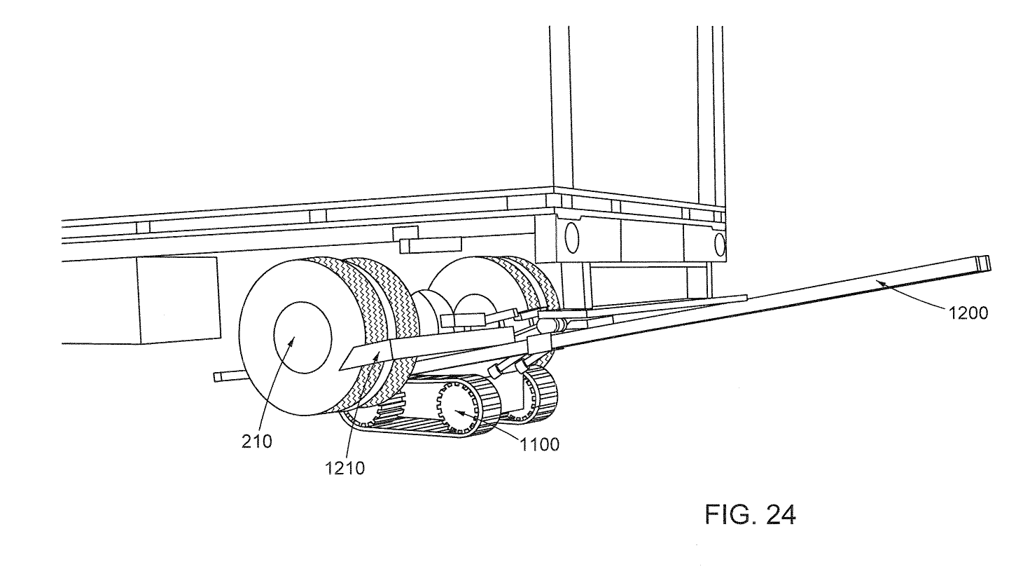

With the load supported, as shown in FIG. 24, the truck assembly 1100 may be driven toward the target vehicle 200 in order to assume completely the load shared with the support rollers 1250. A sleeve, for example, may be provided that is connected to the truck lever 1110 and slidably fit to the inclined rail assembly 1200 so that the truck assembly 1100 may drive forward while maintaining connection to and support of the inclined rail assembly 1200. Depending on the terrain, for example, and/or the above-ground clearance of the target vehicle 200, the truck lever 1110 may be used to control the lift height of the target vehicle 200 to ensure adequate clearance for the truck assembly 1100 to be positioned under the vehicle chassis to take on the full towing load of the target vehicle 200. As the truck assembly 1100 translates along the inclined rail assembly 1200 toward the target vehicle 200, the truck lever 1110 may be controlled to retract accordingly in order to reduce torque on the truck lever 1110 while maintaining the vehicle at the minimum height for providing adequate clearance.

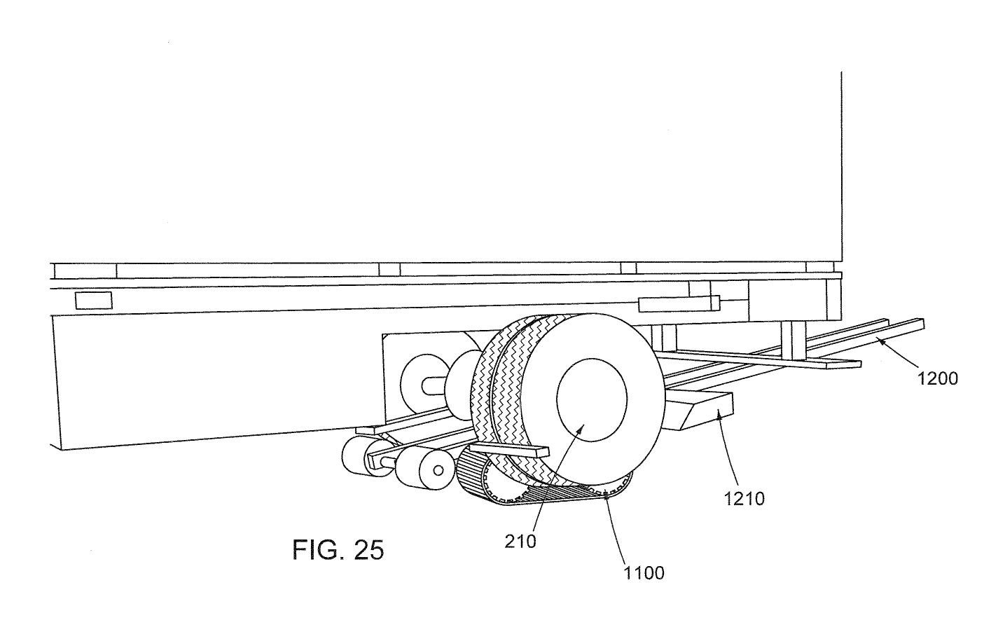

As shown in FIG. 25, with the truck assembly 1100 in position under the drive wheel assembly 1210 and supporting the towing load of the target vehicle 200 entirely on the truck assembly 1100, the VCToR system 1000 may then be controlled by the operator to move the target vehicle 200 to an alternate location.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Although particular aspects of the present invention may be described with respect to an exemplary variant of a towing robot, those same aspects may apply to one or more of the other variants as would be apparent to those having ordinary skill in the art. Various changes may be made without departing from the spirit and scope of the invention. Therefore, the invention is intended to embrace all known or later-developed alternatives, modifications, variations, improvements, and/or substantial equivalents.

What is claimed is:

1. A remotely controlled robot for towing a target vehicle, comprising:
a wheel lift assembly having a left side, a right side, and at least one wheel capture arm;
at least one drive wheel provided toward each of the left and right sides of the wheel lift assembly;
at least one drive motor for driving the drive wheels; and
a lift actuating mechanism;
wherein the wheel capture arm rotates from the wheel lift assembly to secure a wheel of the target vehicle; and
wherein the secured wheel of the target vehicle is raised above a ground surface by the lift actuating mechanism.

2. The remotely controlled robot of claim 1, further comprising a wheel chassis, wherein the wheel lift assembly further comprises a frame axle, left and right side frame bars connected to the frame axle, and at least one lift bar provided on each of the left and right side frame bars, and wherein the lift actuating mechanism is integrated with the wheel chassis to raise the wheel lift assembly via the lift bars.

3. The remotely controlled robot of claim 2, wherein an internal clearance width between the left and right side frame bars is greater than a transverse width of the wheels on the target vehicle.

4. The remotely controlled robot of claim 1, wherein the lift actuating mechanism is a hydraulic lift jack.

5. The remotely controlled robot of claim 1, further comprising:
a navigation system for assisting with the remote control of the robot.

6. The remotely controlled robot of claim 5, wherein the navigation system comprises at least one camera mounted on the wheel lift assembly.

7. The remotely controlled robot of claim 1, wherein each drive wheel is independently mounted with a wheel drive motor.

8. The remotely controlled robot of claim 1, further comprising:
a jack strut connected to the wheel lift assembly and cantilevered to extend in a direction opposite from a direction that the wheel capture arm extends from the wheel lift assembly when wheel capture arm is in a folded inward position.

9. The remotely controlled robot of claim 8, wherein the lift actuating mechanism is a hydraulic jack mounted on a distal end of the cantilevered jack strut.

10. The remotely controlled robot of claim 9, wherein each drive wheel is independently mounted with a wheel drive motor.

11. The remotely controlled robot of claim 1, further comprising:
a load bearing roller wheel, wherein the lift actuating mechanism is a lift jack coupled to the wheel capture arm and the load bearing roller wheel for extending the load bearing roller wheel away from the lift arm.

12. The remotely controlled robot of claim 1, wherein the wheel lift assembly further comprises:
a truck assembly and an inclined rail supported on the truck assembly, and wherein the inclined rail has a proximal end and a distal end, the distal end extending from the truck assembly to be vertically lower than the proximal end.

13. The remotely controlled robot of claim 12, further comprising:
a support beam and a support foot attached to a distal end of the support beam, wherein the support beam slidably extends from the distal end of the inclined rail to place the support foot in abutment with a ground surface.

14. The remotely controlled robot of claim 13, wherein the lift actuating mechanism is a truck lever that is mounted on the truck assembly and connected toward the proximal end of the inclined rail, wherein the truck lever is configured to raise the proximal end of the inclined rail to act in tandem with the support foot to support a target vehicle load in order to allow the truck assembly to translate along the inclined rail toward the target vehicle wheels and assume the entire target vehicle load.

15. The remotely controlled robot of claim 14, further comprising:
a truck lift jack, wherein the truck lever is raised via an extension of the truck lift jack.

16. The remotely controlled robot of claim 1, further comprising:
a rear drive assembly, wherein the drive wheels are coupled to the rear drive assembly and the rear drive assembly is connected to the wheel lift assembly by a rear frame.

17. The remotely controlled robot of claim 16, further comprising:
a front roller assembly having front rollers and a front roller frame, wherein the front roller frame is connected to the rear frame at a pivot point.

18. The remotely controlled robot of claim 17, wherein the front rollers are positioned longitudinally forward and interior of the target vehicle wheels when the wheel capture arm rotates from the wheel lift assembly to secure the wheel of the target vehicle.

19. The remotely controlled robot of claim 18, wherein the lift actuating mechanism longitudinally retracts the front roller assembly and the rear drive assembly toward each other, forcing elevation of the pivot point to raise the target vehicle wheels.

20. The remotely controlled robot of claim 19, wherein the lift actuating mechanism is a hydraulic jack that applies force against to an angled frame element of the rear frame to force the elevation of the pivot point.
